(19) United States
(12) Patent Application Publication
(10) Pub. No.: US 2008/0039585 A1
(43) Pub. Date: Feb. 14, 2008

(54) Thermosetting Resin Composition, Thermosetting Film, Cured Product of Those, and Electronic Component

(75) Inventors: Takashi Nishioka, Tokyo (JP); Hirofumi Gotou, Tokyo (JP); Tsunemitsu Miyata, Tokyo (JP); Shin-ichiro Iwanaga, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR Corporation, Tokyo (JP)

(21) Appl. No.: 11/719,024

(22) PCT Filed: Nov. 9, 2005
(86) PCT No.: PCT/JP05/20547

§ 371 Date: May 10, 2007

(30) Foreign Application Priority Data
Nov. 10, 2004 (JP) 2004-326288
Nov. 30, 2004 (JP) 2004-346198

(51) Int. Cl. C08L 71/02

(52) U.S. Cl. 525/187

(57) ABSTRACT

A thermosetting resin composition of the present invention contains an epoxy resin (A), a crosslinked diene-based rubber (B) in which the content of bonded acrylonitrile is less than 10 wt %, and a curing agent (D) and/or a curing catalyst (E). A cured product obtained by curing the thermosetting resin composition is excellent in properties such as electric insulation properties and electrical properties.

### TECHNICAL FIELD

The present invention relates to a thermosetting resin composition, a thermosetting film, cured products thereof, and an electronic component. In more detail, it relates to a thermosetting resin composition that can provide a cured product excellent in electrical properties such as electric insulation properties including low dielectric constant and low dielectric loss, a thermosetting film using the composition, cured products thereof, and an electronic component having an insulating layer formed using the composition.

### BACKGROUND ART

Recently, electronic components mounted on precision mechanical equipment such as electronic devices and communication apparatuses have higher speed, smaller size, reduced thickness, lighter weight and higher density and are required to have higher reliability.

With increases in density, precision and fineness, such electronic components more often have a multilayer structure, and multilayer circuit boards and similar electronic components require interlayer insulating films or flattening films. Resin materials for such interlayer insulating films or flattening films are required to have excellent electric insulation between conductors and excellent heat resistance to withstand heat generation and high-temperature soldering.

Conventionally, such circuit boards are manufactured by impregnating a reinforced base such as glass cloth with a resin varnish, laminating a copper foil on the impregnated base, and subsequently heat-curing. The resin materials for these circuit boards are usually thermosetting resins such as polyimides, phenolic resins and epoxy resins.

However, these resins generally have high dielectric constants of 3.5 or more and insufficient electrical properties, causing a problem that speed-up of arithmetic processing is difficult with electronic components using these materials. Even if the resins attain good electrical properties, they have another problem that the heat resistance is inferior. Furthermore, although these resins have satisfactory initial physical properties, they change physical properties, for example increase the elastic modulus, during reliability tests such as thermal shock test and insulation durability test. Such property changes cause cracking, breaking and the like. Therefore, resin materials having well-balanced properties are demanded.

Regarding insulating materials aimed at preventing cracks and balancing (thermal) shock resistance, heat resistance and electrical insulation properties, use of a crosslinked acrylonitrile rubber with small particle diameters is disclosed (see Patent Document 1). For similar purposes, use of a crosslinked acrylonitrile rubber in which the average secondary particle diameter is 0.5 to 2 μm is disclosed (see Patent Document 2). However, these elastic materials used in the above technologies usually contain 20% or more of acrylonitrile-derived units. Although the compatibility of the elastic material with an epoxy resin and other components is good, the obtainable insulating resins tend to be inferior in electrical properties such as dielectric constant and dielectric dissipation factor, and in insulation reliability. Moreover, the rubbers used in these technologies include a diene and are therefore generally liable to degradation by heat or other factors, and they often change physical properties, for example reduce the rubber elasticity, due to chemical changes during reliability tests such as thermal shock test. Consequently, electronic components having insulating layers of such resins have a short lifetime.

On the other hand, thermosetting materials including polyimides, phenolic resins, epoxy resins and the like are generally hard and brittle. To improve their toughness and adhesion to metal conductors such as copper, these resin materials are blended with acrylonitrile/butadiene copolymer or carboxylated acrylonitrile/butadiene copolymer which has good compatibility with these resins (see Patent Documents 3 to 6). Considering future increase in speed and density of electronic circuits, however, there is a need for thermosetting materials that have still lower dielectric constant and dielectric loss than those of the thermosetting materials containing such acrylonitrile copolymers.

Generally, it is known that styrene/butadiene-based copolymers are excellent in electrical properties because of their structures. However, general styrene/butadiene copolymers have poor compatibility with thermosetting resins such as epoxy resins, and hence these components are separated from each other during mixing or curing reaction, making it difficult to form uniform cured films.

Patent Documents 7 to 9 are directed to improving low dielectric constant properties and low dielectric loss properties. These documents propose thermosetting resin compositions and cured products thereof, wherein the compositions contain hollow crosslinked resin particles prepared by polymerizing styrene/butadiene/itaconic acid copolymer particles with divinylbenzene. It is also disclosed that the cured products have lower dielectric constant, lower dielectric loss, and more excellent insulation properties compared with cured products that contain spherical non-crosslinked resin particles prepared by polymerizing the styrene/butadiene/itaconic acid copolymer particles with methyl methacrylate. Although the cured products achieve lower dielectric constant and lower dielectric loss compared with the thermosetting materials containing the acrylonitrile copolymers, they tend to show reduced insulation resistance. Moreover, since the hollow crosslinked resin particles are produced by copolymerizing the styrene/butadiene/itaconic acid copolymer as seed polymer with divinylbenzene, the particles have poor compatibility with epoxy resins and phenolic resins. Furthermore, the particles have a high glass transition temperature. Consequently, the cured products containing the hollow crosslinked resin particles tend to have poor thermal shock resistance (crack resistance).

Accordingly, in order to provide for future higher speed and higher density of electronic circuits, there is a demand for cured products with lower dielectric constants, lower dielectric loss and more excellent insulation properties, and for thermosetting resin compositions capable of giving such cured products.

Compositions known to be used for forming insulating layers include an epoxy resin composition that contains an epoxy resin containing a multifunctional epoxy resin as an essential component, rubbery elastic particles incompatible with the epoxy resin, and a curing agent containing a phenol-novolak resin as an essential component (Patent Document 10), and a resin composition prepared using an epoxy resin as a base resin, a phenol-novolak resin as a curing agent, and an imidazole silane as a coupling agent (Patent Document 11). However, the former composition is directed to suppressing the thermal expansion of the insulating layer, and the latter composition is directed to improving the adhesion between an inner-layer circuit and the insulating layer while maintaining high heat resistance.

[Patent Document 1] Japanese Patent Laid-Open Publication No. H8-139457

[Patent Document 2] Japanese Patent Laid-Open Publication No. 2003-113205

[Patent Document 3] Japanese Patent Laid-Open Publication No.

[Patent Document 4] Japanese Patent Laid-Open Publication No. 2002-60467

[Patent Document 5] Japanese Patent Laid-Open Publication No. 2003-246849

[Patent Document 6] Japanese Patent Laid-Open Publication No. 2003-318499

[Patent Document 7] Japanese Patent Laid-Open Publication No. 2000-311518

[Patent Document 8] Japanese Patent Laid-Open Publication No. 2000-313818

[Patent Document 9] Japanese Patent Laid-Open Publication No. 2000-315845

[Patent Document 10] Japanese Patent Laid-Open Publication No. 2003-246849

[Patent Document 11] Japanese Patent Laid-Open Publication No. 2003-318499

### DISCLOSURE OF THE INVENTION

### Problems to be Solved by the Invention

The present invention is directed to solving the above problems of conventional art, and the first object of the invention is to provide a cured product excellent in electric insulation properties, electrical properties and other characteristics; and a thermosetting resin composition capable of giving such a cured product. In addition to the first object, the invention has a second object to provide a cured product that shows only quite minor changes in physical properties during a reliability test, has a high glass transition temperature, and is excellent in characteristics such as thermal shock resistance and heat resistance; and a thermosetting resin composition capable of giving such a cured product.

The present invention has still another object to provide, using the thermosetting resin composition, a highly reliable electronic component resistant to cracks, breaking and other troubles induced by thermal stress.

### Means to Solve the Problems

The inventors have intensively studied to solve the above problems and have found that a thermosetting resin composition composed of an epoxy resin, a diene-based rubber in which the content of bonded acrylonitrile is less than 10 wt %, and a curing agent and/or a curing catalyst can give a cured product with excellent electrical properties such as low dielectric constant and low dielectric loss and excellent electric insulation properties. They have completed the invention based on the finding. The inventors have also found that use of a diene-based rubber having a specific functional group or an antioxidant in the composition provides a cured product that shows only quite minor changes in physical properties during a reliability test and is excellent in mechanical properties, heat resistance, thermal shock resistance and reliability. They have completed the invention based on the finding.

That is, a thermosetting resin composition according to the present invention comprises an epoxy resin (A), a crosslinked diene-based rubber (B) in which the content of bonded acrylonitrile is less than 10 wt %, and a curing agent (D) and/or a curing catalyst (E).

The crosslinked diene-based rubber (B) is preferably a copolymer which has one or more glass transition temperatures of which at least one glass transition temperature is 0° C. or less, and which includes units derived from a crosslinking monomer having at least two polymerizable unsaturated bonds and is free of acrylonitrile. The rubber (B) is preferably a styrene/butadiene-based copolymer having at least one kind of functional group selected from carboxyl group, hydroxyl group and epoxy group.

The styrene/butadiene-based copolymer is preferably obtained from 5 to 40 parts by weight of styrene, 40 to 90 parts by weight of butadiene, and 1 to 30 parts by weight of a monomer having at least one kind of functional group selected from carboxyl group, hydroxyl group and epoxy group, based on 100 parts by weight of the material monomers combined. Also preferably, the styrene/butadiene-based copolymer is obtained from 5 to 40 parts by weight of styrene, 40 to 90 parts by weight of butadiene, 1 to 30 parts by weight of a monomer having at least one kind of functional group selected from carboxyl group, hydroxyl group and epoxy group, and 0.5 to 10 parts by weight of a monomer having at least two polymerizable unsaturated double bonds, based on 100 parts by weight of the material monomers combined.

The crosslinked diene-based rubber (B) is preferably in a form of crosslinked fine particles. The diameters of the crosslinked fine particles are preferably in the range of 30 to 500 nm.

The thermosetting resin composition is preferably capable of giving a heat-cured product having an elastic modulus of 1.5 GPa or less.

A cured product according to the present invention is obtained by heat-curing the above thermosetting resin composition.

A thermosetting film according to the present invention comprises the above thermosetting resin composition. A cured film according to the present invention is obtained by heat-curing the thermosetting film.

An electronic component according to the present invention has an insulating layer comprising the above thermosetting resin composition.

### EFFECTS OF THE INVENTION

The thermosetting resin composition according to the present invention has excellent compatibility of the components and is capable of giving a cured product with excellent mechanical properties, insulation properties and electrical properties (low dielectric constant and low dielectric loss). The cured product exhibits only quite minor changes in physical properties during a reliability test and has excellent heat resistance, thermal shock resistance and reliability.

### BRIEF DESCRIPTION OF THE DRAWINGS

FIG. 1 is a cross-sectional view of a patterned board for evaluating thermal shock resistance.

FIG. 2 illustrates an upper surface of the patterned board for evaluating thermal shock resistance.

### DESCRIPTION OF THE SYMBOLS

1 Metal (copper) pad
2 Substrate (silicon wafer)
3 Patterned board

### BEST MODES FOR CARRYING OUT THE INVENTION

[Thermosetting Resin Composition]

The thermosetting resin composition according to the present invention contains an epoxy resin (A), a crosslinked diene-based rubber (B) in which the content of bonded acrylonitrile is less than 10 wt %, and a curing agent (D) and/or a curing catalyst (E). The thermosetting resin composition may further contain an antioxidant (C), a polymer, an organic solvent, an inorganic filler, an adhesion auxiliary, a surfactant, and other additives, as required.

First, each component used in the present invention will be explained.

(A) Epoxy Resin

The epoxy resin (A) used in the present invention is not particularly limited and may be any of epoxy resins used for interlayer insulating films or flattening films of multilayer circuit boards, or protective films, electrical insulating films or other films of electronic components. Specific examples include:

bisphenol A-type epoxy resin, bisphenol F-type epoxy resin, hydrogenated bisphenol A-type epoxy resin, hydrogenated bisphenol F-type epoxy resin, bisphenol S-type epoxy resin, brominated bisphenol A-type epoxy resin, biphenyl-type epoxy resin, naphthalene-type epoxy resin, fluorene-type epoxy resin, spirocyclic epoxy resin, bisphenol alkane-type epoxy resin, phenol novolak-type epoxy resin, o-cresol novolak-type epoxy resin, brominated cresol novolak-type epoxy resin, tris-hydroxymethane-type epoxy resin, tetraphenylolethane-type epoxy resin, alicyclic epoxy resin, alcohol-type epoxy resin, butyl glycidyl ether, phenyl glycidyl ether, cresyl glycidyl ether, nonyl glycidyl ether, diethylene glycol diglycidyl ether, polyethylene glycol diglycidyl ether, polypropylene glycol diglycidyl ether, glycerol polyglycidyl ether, neopentyl glycol diglycidyl ether, 1,6-hexanediol diglycidyl ether, trimethylolpropane triglycidyl ether, hexahydrophthalic acid diglycidyl ether, fatty acid-modified epoxy resin, toluidine-type epoxy resin, aniline-type epoxy resin, aminophenol-type epoxy resin, 1,3-bis(N,N-diglycidylaminomethyl)cyclohexane, hydantoin-type epoxy resin, triglycidyl isocyanurate, tetraglycidyldiaminodiphenylmethane, diphenyl ether-type epoxy resin, dicyclopentadiene-type epoxy resin, dimer acid diglycidyl ester, diglycidyl hexahydrophthalate, dimer acid diglycidyl ether, silicone-modified epoxy resin, silicon-containing epoxy resin, urethane-modified epoxy resin, NBR-modified epoxy resin, CTBN-modified epoxy resin, epoxidizedpolybutadiene, glycidyl (meth)acrylate (co)polymer and allyl glycidyl ether (co)polymer. These epoxy resins may be used singly or as a mixture of two or more kinds.

(B) Crosslinked Diene-Based Rubber in which the Content of Bonded Acrylonitrile is Less than 10 Wt %

In the crosslinked diene-based rubber (B) used in the present invention, the content of bonded acrylonitrile is less than 10 wt %, preferably less than 8 wt %, and especially preferably 0 wt %. The crosslinked diene-based rubber (B) used in the present invention is desirably a copolymer having one or more glass transition temperatures (Tg) of which at least one glass transition temperature is 0° C. or less, preferably −100° C. to 0° C., and more preferably −80° C. to −20° C. When Tg of the crosslinked diene-based rubber (B) is within the above range, the cured product (cured film) of the thermosetting resin composition has excellent flexibility (crack resistance). On the other hand, when Tg exceeds the above upper limit, the cured product is inferior in crack resistance, possibly resulting in many cracks on the substrate surface under environments with large temperature variation.

Such crosslinked diene-based rubber (B) is preferably, for example, a copolymer of a crosslinking monomer having at least two polymerizable unsaturated bonds (hereafter, simply referred to as “crosslinking monomer”) and a monomer other than this crosslinking monomer (hereafter, referred to as “comonomer”), wherein the comonomer is at least one comonomer selected such that Tg of the copolymer will be 0° C. or less. Further preferred comonomers include monomers having a functional group that contains no polymerizable unsaturated bond, for example, carboxyl group, epoxy group, amino group, isocyanate group or hydroxyl group.

Specific examples of the crosslinking monomers include compounds having at least two polymerizable unsaturated bonds, such as divinylbenzene, diallyl phthalate, ethylene glycol di(meth)acrylate, propylene glycol di(meth)acrylate, trimethylolpropane tri(meth)acrylate, pentaerythritol tri(meth)acrylate, polyethylene glycol di(meth)acrylate, and polypropylene glycol di(meth)acrylate. Among these, divinylbenzene is preferably used.

Specific examples of the comonomers include:

vinyl compounds such as butadiene, isoprene, dimethylbutadiene, and chloroprene;

unsaturated nitriles such as 1,3-pentadiene, (meth)acrylonitrile, α-chloroacrylonitrile, α-chloromethylacrylonitrile, α-methoxyacrylonitrile, α-ethoxyacrylonitrile, crotononitrile, cinnamonitrile, itaconic acid dinitrile, maleic acid dinitrile, and fumaric acid dinitrile; unsaturated amides such as (meth)acrylamide, N,N′-methylenebis(meth)acrylamide, N,N′-ethylenebis(meth)acrylamide, N,N′-hexamethylenebis(meth)acrylamide, N-hydroxymethyl(meth)acrylamide, N-(2-hydroxyethyl)(meth)acrylamide, N,N′-bis(2-hydroxyethyl) (meth) acrylamide, crotonamide, and cinnamamide;

(meth)acrylic esters such as methyl (meth)acrylate, ethyl (meth)acrylate, propyl (meth)acrylate, butyl (meth)acrylate, hexyl (meth)acrylate, lauryl (meth)acrylate, polyethylene glycol (meth)acrylate, and polypropylene glycol (meth)acrylate;

aromatic vinyl compounds such as styrene, α-methylstyrene, o-methoxystyrene, p-hydroxystyrene, and p-isopropenylphenol;

epoxy (meth)acrylates obtained by reaction of bisphenol A diglycidyl ether, a glycol diglycidyl ether or the like with (meth) acrylic acid, a hydroxyalkyl (meth)acrylate or the like;

urethane (meth)acrylates obtained by reaction of a hydroxyalkyl (meth)acrylate with a polyisocyanate;

epoxy group-containing unsaturated compounds such as glycidyl (meth)acrylate and (meth)allyl glycidyl ether;

unsaturated acid compounds such as (meth) acrylic acid, itaconic acid, β-(meth)acryloxyethyl succinate, β-(meth)acryloxyethyl maleate, β-(meth)acryloxyethyl phthalate, and β-(meth)acryloxyethyl hexahydrophthalate;

amino group-containing unsaturated compounds such as dimethylamino(meth)acrylates and diethylamino(meth)acrylates;

amide group-containing unsaturated compounds such as (meth)acrylamide, and dimethyl (meth)acrylamide; and

hydroxyl group-containing unsaturated compounds such as hydroxyethyl (meth)acrylate, hydroxypropyl (meth)acrylate, and hydroxybutyl (meth)acrylate.

Among these, preferred are butadiene, isoprene, (meth)acrylonitrile, alkyl (meth)acrylates, styrene, p-hydroxystyrene, p-isopropenylphenol, glycidyl (meth)acrylate, (meth)acrylic acid, and hydroxyalkyl (meth)acrylates.

Preferred examples of the crosslinked diene-based rubber (B) used in the present invention include crosslinked rubbers obtained from the vinyl compound, aromatic vinyl compound, unsaturated acid, and crosslinking monomer; crosslinked rubbers obtained from the vinyl compound, aromatic vinyl compound, hydroxyl group-containing unsaturated acid, and crosslinking monomer; and crosslinked rubbers obtained from the vinyl compound, unsaturated nitrile, unsaturated acid compound, hydroxyl group-containing aromatic vinyl compound, and crosslinking monomer.

In the present invention, the amount of the crosslinking monomer used for producing the crosslinked diene-based rubber is preferably 1 to 20 wt %, more preferably 2 to 10 wt %, in the total amount of monomers.

The method for producing the crosslinked diene-based rubber (B) is not particularly limited; for example, emulsion polymerization may be employed. In emulsion polymerization, the monomers including the crosslinking monomer are emulsified in water using a surfactant; a radical polymerization initiator such as a peroxide catalyst or a redox-type catalyst is added; and a molecular-weight modifier such as a mercaptan compound or a halogenated hydrocarbon is added as required. The polymerization is conducted at 0 to 50° C. until the polymerization conversion reaches a predetermined value, and the reaction is stopped by adding a reaction terminator such as N,N-diethylhydroxylamine. Unreacted monomers in the polymerization system are removed by steam distillation or the like to yield the crosslinked diene-based rubber (B).

Any surfactants that enable production of the crosslinked diene-based rubber (B) by emulsion polymerization can be used without particular limitations. Usable surfactants include, for example, anionic surfactants such as alkylnaphthalenesulfonates and alkylbenzenesulfonates; cationic surfactants such as alkyltrimethylammonium salts and dialkyldimethylammonium salts; nonionic surfactants such as polyoxyethylene alkyl ethers, polyoxyethylene alkyl allyl ethers, polyoxyethylene fatty acid esters, polyoxyethylene sorbitan fatty acid esters, and fatty acid monoglycerides; amphoteric surfactants; and reactive emulsifiers. These surfactants may be used singly or as a mixture of two or more kinds.

Alternatively, the crosslinked diene-based rubber (B) may be obtained as solid by a series of steps in which the crosslinked diene-based rubber (B) is solidified, for example salted out, from a latex that is obtained in the above emulsion polymerization, and the salted-out rubber is washed with water and dried. When the nonionic surfactant is used, the crosslinked diene-based rubber (B) contained in the latex may be solidified by other than salting out, i.e., by heating the latex to at least the cloud point of the nonionic surfactant. In the case where the polymerization uses a surfactant other than the nonionic surfactant, the crosslinked diene-based rubber (B) may be solidified by adding the nonionic surfactant after the polymerization and heating the latex to at least the cloud point of the surfactant.

Still alternatively, the crosslinked diene-based rubber (B) may be produced using no crosslinking monomer. Examples of such methods include a method in which a crosslinking agent such as a peroxide is added to the latex to crosslink the rubber particles in the latex, a method in which the latex including the rubber particles is gelled by increasing the polymerization conversion, and a method in which a crosslinking agent such as a metal salt is added to crosslink the particles in the latex by means of functional groups such as carboxyl groups.

The particle diameters of the crosslinked diene-based rubber (B) used in the present invention are typically 30 to 500 nm, and preferably 40 to 200 nm. When the particle diameters of the crosslinked diene-based rubber (B) are within the above range, the resultant cured film is excellent in characteristics such as mechanical properties and thermal shock resistance.

The method for controlling the particle diameters of the crosslinked diene-based rubber (B) is not particularly limited. For example, when the crosslinked rubber particles are synthesized by emulsion polymerization, the particle diameters can be controlled by regulating the number of micelles during the emulsion polymerization by adjusting the quantity of the emulsifier used.

In the present invention, it is preferred to blend the crosslinked diene-based rubber (B) in an amount of 5 to 200 parts by weight, preferably 10 to 150 parts by weight, relative to 100 parts by weight of the epoxy resin (A). Any amount less than the above-described lower limit sometimes reduces thermal shock resistance of the cured film obtained by heat-curing the thermosetting resin composition, while any amount exceeding the above-described upper limit sometimes lowers the heat resistance of the cured film or decreases the compatibility with other components in the thermosetting resin composition.

<Case where Crosslinked Diene-Based Rubber (B) is Styrene/Butadiene-Based Copolymer>

The styrene/butadiene-based copolymer (hereafter, often referred to as “SB copolymer”) used for the present invention has at least one kind of functional group selected from carboxyl group, hydroxyl group and epoxy group. Having at least one kind of functional group selected from carboxyl group, hydroxyl group and epoxy group, the SB copolymer shows excellent compatibility with the epoxy resin (A).

In terms of improving the thermal shock resistance, the glass transition temperature (Tg) of the SB copolymer is usually 0° C. or less, preferably −10° C. or less, and more preferably −20° C. or less. When the SB copolymer has Tg in the above range, the cured product (cured film) of the thermosetting resin composition shows excellent flexibility (crack resistance). In contrast, when Tg exceeds the above-described upper limit, the cured product is inferior in crack resistance, possibly resulting in many cracks on the substrate surface under environments with large temperature variation. In the present invention, Tg of the SB copolymer is measured as follows. The SB copolymer is precipitated from a liquid dispersion and dried, and the copolymer is heated with a differential scanning calorimeter (SSC/5200H; manufactured by Seiko Instruments) at a heating rate of 10° C./min from −100° C. to 150° C. (“DSC method”).

The SB copolymer used for the present invention can be produced by copolymerizing styrene, butadiene, and a monomer having at least one kind of functional group selected from carboxyl group, hydroxyl group and epoxy group (hereafter, also referred to as “specific functional group-containing monomer”). In this case, it is desirable to copolymerize typically 5 to 40 parts by weight, preferably 15 to 25 parts by weight of styrene; typically 40 to 90 parts by weight, preferably 50 to 80 parts by weight of butadiene; and typically 1 to 30 parts by weight, preferably 5 to 25 parts by weight of the specific functional group-containing monomer, wherein the total of the material monomers is 100 parts by weight. When the material monomers are copolymerized in the above amounts, the styrene/butadiene-based copolymer obtained is excellent in compatibility with the epoxy resin and is capable of giving a cured product with excellent electrical properties such as low dielectric constant and low dielectric loss, excellent electric insulation properties, and excellent thermal shock resistance.

The SB copolymer in a form of crosslinked fine particles may be produced by copolymerizing styrene, butadiene, the specific functional group-containing monomer, and a monomer having at least two polymerizable unsaturated double bonds (hereafter, also referred to as “crosslinking monomer”). Here, it is desirable to copolymerize typically 5 to 40 parts by weight, preferably 15 to 25 parts by weight of styrene; typically 40 to 90 parts by weight, preferably 50 to 80 parts by weight of butadiene; typically 1 to 30 parts by weight, preferably 5 to 25 parts by weight of the specific functional group-containing monomer; and typically 0.5 to 10 parts by weight, preferably 1 to 5 parts by weight of the crosslinking monomer, wherein the total of the material monomers is 100 parts by weight. When the material monomers are copolymerized in the above amounts, the styrene/butadiene-based copolymer obtained is excellent in compatibility with the epoxy resin and is capable of giving a cured product having excellent electrical properties such as low dielectric constant and low dielectric loss, excellent electric insulation properties, and excellent thermal shock resistance.

Production of the SB copolymer may involve an additional monomer together with styrene, butadiene, the specific functional group-containing monomer and the crosslinking monomer (hereafter, such monomer will be referred to as “additional monomer”).

In the present invention, it is desirable that styrene, butadiene, the specific functional group-containing monomer, and optionally the crosslinking monomer as required are copolymerized simultaneously. The SB copolymer thus obtained is particularly excellent in compatibility with the epoxy resin (A).

The SB copolymer consisting solely of styrene, butadiene and the specific functional group-containing monomer gives a cured product with superior insulation properties.

Examples of the specific functional group-containing monomers include carboxyl group-containing monomers, hydroxyl group-containing monomers, and epoxy group-containing monomers. These monomers may be used singly or as a mixture of two or more kinds.

The carboxyl group-containing monomers include acrylic acid, methacrylic acid, itaconic acid, 2-(meth)acryloyloxyethylsuccinic acid, 2-(meth)acryloyloxyethylmaleic acid, 2-(meth)acryloyloxyethylphthalic acid, 2-(meth) acryloyloxyethylhexahydrophthalic acid, acrylic acid dimer, and ω-carboxy-polycaprolactone monoacrylate.

The hydroxyl group-containing monomers include hydroxyethyl (meth)acrylate, hydroxypropyl (meth)acrylate, hydroxybutyl (meth)acrylate, 2-hydroxy-3-phenoxypropyl (meth)acrylate, and 2-hydroxy-3-phenoxypropyl (meth)acrylate.

The epoxy group-containing monomers include glycidyl (meth)acrylate, and allyl glycidyl ether.

Preferably, the SB copolymer contains constitutional units derived from the specific functional group-containing monomer(s) in an amount of 0.1 mol % to 30 mol %, more preferably 0.5 mol % to 20 mol %, based on 100 mol % of the constitutional units derived from the monomers of the SB copolymer.

Examples of the crosslinking monomers include compounds having at least two polymerizable unsaturated groups, such as divinylbenzene, diallyl phthalate, ethylene glycol di(meth)acrylate, propylene glycol di (meth)acrylate, trimethylolpropane tri(meth)acrylate, pentaerythritol tri(meth)acrylate, polyethylene glycol di(meth)acrylate, and polypropylene glycol di(meth)acrylate.

Examples of the additional monomers include diene-type monomers such as isoprene, dimethylbutadiene, chloroprene, and 1,3-pentadiene; unsaturated amides such as (meth)acrylamide, N,N′-methylenebis(meth)acrylamide, N,N′-ethylenebis(meth)acrylamide, N,N′-hexamethylenebis(meth)acrylamide, N-hydroxymethyl(meth)acrylamide, N-(2-hydroxyethyl)(meth)acrylamide, N,N′-bis(2-hydroxyethyl) (meth)acrylamide, crotonamide, and cinnamamide; (meth)acrylates such as methyl (meth)acrylate, ethyl (meth)acrylate, propyl (meth)acrylate, butyl (meth)acrylate, hexyl (meth)acrylate, lauryl (meth)acrylate, polyethylene glycol (meth)acrylate, and polypropylene glycol (meth)acrylate; aromatic vinyl compounds such as α-methylstyrene, o-methoxystyrene, p-hydroxystyrene, and p-isopropenylphenol; epoxy (meth)acrylates obtained by reaction of bisphenol A diglycidyl ether, a glycol diglycidyl ether or the like with (meth)acrylic acid, a hydroxyalkyl (meth)acrylate or the like; urethane (meth)acrylates obtained by reaction of a hydroxyalkyl (meth)acrylate with a polyisocyanate; and amino group-containing unsaturated compounds such as dimethylamino(meth)acrylates and diethylamino(meth)acrylates.

(Method for Producing Sb Copolymer)

The method for producing the styrene/butadiene-based copolymer is not particularly limited. For example, emulsion polymerization and suspension polymerization may be used.

In emulsion polymerization, the monomers are emulsified in water using a surfactant; a radical polymerization initiator such as a peroxide catalyst or a redox-type catalyst is added; and a molecular-weight modifier such as a mercaptan compound or a halogenated hydrocarbon is added as required. The polymerization is conducted at 0 to 50° C. until the polymerization conversion reaches a predetermined value, and the reaction is stopped by adding a reaction terminator such as N,N-diethylhydroxylamine. Unreacted monomers in the polymerization system are removed by steam distillation or the like to yield a copolymer emulsion. This copolymer emulsion is added to an aqueous electrolyte solution having a predetermined concentration, and the deposited copolymer is dried. The copolymer is thus isolated.

By adding the crosslinking monomer in the above copolymerization, the crosslinked fine particles are obtained. Alternatively, the crosslinked fine particles may be produced using no crosslinking monomer. Examples of such methods include a method in which a crosslinking agent such as a peroxide is added to the latex to crosslink the rubber particles in the latex, a method in which the latex including the rubber particles is gelled by increasing the polymerization conversion, and a method in which a crosslinking agent such as a metal salt is added to crosslink the particles in the latex by means of functional groups such as carboxyl groups.

When the nonionic surfactant is used, the copolymer may be solidified by other than salting out, i.e., by heating the latex to at least the cloud point of the nonionic surfactant. In the case where the polymerization uses a surfactant other than the nonionic surfactant, the copolymer may be solidified by adding the nonionic surfactant after the polymerization and heating the latex to at least the cloud point of the surfactant.

The surfactants used in producing the SB copolymer by emulsion polymerization are not particularly limited. Examples of the surfactants include anionic surfactants such as alkylbenzenesulfonates; cationic surfactants such as alkylnaphthalenesulfonates, alkyltrimethylammonium salts and dialkyldimethylammonium salts; nonionic surfactants such as polyoxyethylene alkyl ethers, polyoxyethylene alkyl allyl ethers, polyoxyethylene fatty acid esters, polyoxyethylene sorbitan fatty acid esters, and fatty acid monoglycerides; amphoteric surfactants; and reactive emulsifiers. These surfactants may be used singly or as a mixture of two or more kinds.

In the present invention, when the SB copolymer is in a particulate form such as crosslinked fine particles or non-crosslinked fine particles, the particle diameter is typically 30 to 500 nm, preferably 40 to 200 nm, and further preferably 45 to 100 nm. In the present invention, the average particle diameter of the particulate copolymer is measured using a light-scattering particle size distribution analyzer (LPA-3000; manufactured by Otsuka Electronics Co. Ltd.) with a liquid dispersion of the particulate copolymer diluted according to the usual method.

The method for controlling the particle diameter of the particulate copolymer is not particularly limited. For example, when the particulate copolymer is synthesized by emulsion polymerization, the particle diameter can be controlled by regulating the number of micelles during the emulsion polymerization by adjusting the quantity of the emulsifier used.

In the present invention, the amount of the SB copolymer to be blended is typically 1 to 150 parts by weight, preferably 5 to 100 parts by weight, relative to 100 parts by weight of the epoxy resin (A). When the copolymer is blended in an amount not less than the above-described lower limit, the obtainable cured film shows improved toughness and is more resistant to cracks over long-term use. When the copolymer is blended in an amount not more than the above-described upper limit, the compatibility of the SB copolymer with other components is improved and the obtainable cured product shows improved heat resistance.

(C) Antioxidant

The antioxidants for use in the present invention include phenolic antioxidants, sulfur-type antioxidants, and amine-type antioxidants. In particular, phenolic antioxidants are preferred. The use of antioxidant leads to quite minor property changes during a reliability test, and extended service life of electronic components.

Specific examples of the phenolic antioxidants include 2,6-di-t-butyl-4-methylphenol, 2,6-di-t-butyl-p-ethylphenol, 2,4,6-tri-t-butylphenol, butylhydroxyanisole, 1-hydroxy-3-methyl-4-isopropylbenzene, mono-t-butyl-p-cresol, mono-t-butyl-m-cresol, 2,4-dimethyl-6-t-butylphenol, triethylene glycol bis[3-(3-t-butyl-5-methyl-4-hydroxyphenyl) propionate], 1,6-hexanediol bis[3-(3,5-di-t-butyl-4-hydroxyphenyl) propionate], 2,4-bis(n-octylthio)-6-(4-hydroxy-3,5-di-t-butylanilino)-1,3,5-triazine, 2,2-thio-diethylene bis[3-(3,5-di-t-butyl-4-hydroxyphenyl) propionate], pentaerythrityl tetrakis[3-(3,5-di-t-butyl-4-hydroxyphenyl) propionate], 2,2′-methylene-bis(4-methyl-6-t-butylphenol), 2,2′-methylenebis(4-ethyl-6-t-butylphenol), 2,2′-methylenebis(4-methyl-6-t-nonylphenol), 2,2′-isobutylidenebis(4,6-dimethylphenol), 4,4′-butylidenebis(3-methyl-6-t-butylphenol), 4,4′-methylenebis(2,6-di-t-butylphenol), 2,2-thiobis(4-methyl-6-t-butylphenol), 4,4′-thiobis(3-methyl-6-t-butylphenol), 4,4′-thiobis(2-methyl-6-butylphenol), 4,4′-thiobis(6-t-butyl-3-methylphenol), bis(3-methyl-4-hydroxy-5-t-butylbenzene) sulfide, 2,2-thio[diethyl-bis-3-(3,5-di-t-butyl-4-hydroxyphenol) propionate], bis[3,3-bis(4′-hydroxy-3′-t-butylphenol)butyric acid] glycol ester, bis[2-(2-hydroxy-5-methyl-3-t-butylbenzene)-4-methyl-6-t-butylphenyl] terephthalate, 1,3,5-tris(3′,5′-di-t-butyl-4′-hydroxybenzyl) isocyanurate, N,N′-hexamethylenebis(3,5-di-t-butyl-4-hydroxy-hydroxyamide), N-octadecyl-3-(4′-hydroxy-3′,5′-di-t-butylphenol) propionate, tetrakis[methylene-(3′,5′-di-t-butyl-4-hydroxyphenyl) propionate]methane, 1,1′-bis(4-hydroxyphenyl)cyclohexane, mono(α-methylbenzene)phenol, di(α-methylbenzyl)phenol, tri(α-methylbenzyl)phenol, bis(2′-hydroxy-3′-t-butyl-5′-methylbenzyl)-4-methyl-phenol, 2,5-di-t-amylhydroquinone, 2,6-di-butyl-α-dimethylamino-p-cresol, 2,5-di-t-butylhydroquinone, and diethyl 3,5-di-t-butyl-4-hydroxybenzylphosphate.

Specific examples of the amine-type antioxidants include bis(2,2,6,6-tetramethyl-4-piperidyl) sebacate, tetrakis(1,2,2,6,6-pentamethyl-4-piperidyl) 1,2,3,4-butanetetracarboxylate, tetrakis(2,2,6,6-tetramethyl-4-piperidyl) 1,2,3,4-butanetetracarboxylate, 1,2,2,6,6-pentamethyl-4-piperidyl tridecyl 1,2,3,4-butanetetracarboxylate, 1,2,3,4-butanetetracarboxylic acid/1,2,2,6,6-pentamethyl-4-piperidinol/β,β,β′,β′-tetramethyl-3,9-(2,4,8,10-tetraoxaspiro[5.5]undecane)diethanol condensate, dimethyl succinate/1-(2-hydroxyethyl)-4-hydroxy-2,2,6,6-tetramethylppiperidine polycondensate, and poly[[6-(1,1,3,3-tetramethylbutyl)amino-1,3,5-triazine-2,4-diyl][(2,2,6,6-tetramethyl-4-piperidyl)imino]hexamethylene[(2,2,6,6-tetramethyl-4-piperidyl)imino]]. Preferred examples include tetrakis (1,2,2,6,6-pentamethyl-4-piperidyl) 1,2,3,4-butanetetracarboxylate, and 1,2,2,6,6-pentamethyl-4-piperidyl/tridecyl 1,2,3,4-butanetetracarboxylate, which are tertiary >N—R type hindered amine-type antioxidants.

Specific examples of the sulfur-type antioxidants include dilauryl thiopropionate. These antioxidants may be used singly or as a mixture of two or more kinds. The amount of the antioxidant(s) is preferably 0.1 to 20 parts by weight, especially preferably 0.5 to 10 parts by weight, relative to 100 parts by weight of the component (A).

(D) Curing Agent

The curing agent (D) used in the present invention is not particularly limited as long as it undergoes curing reaction with the epoxy groups in the resins. Examples thereof include aliphatic and aromatic amines, phenols, acid anhydrides, polyamide resins, phenolic resins, polysulfide resins, and polyvinylphenols.

The amines include diethylamine, diethylenetriamine, triethylenetetramine, diethylaminopropylamine, aminoethylpiperazine, menthenediamine, m-xylylenediamine, dicyandiamide, diaminodiphenylmethane, diaminodiphenyl sulfone, methylenedianiline, and m-phenylenediamine.

The phenols are not particularly limited as long as they have a phenolic hydroxyl group. Examples thereof include biphenol, bisphenol A, bisphenol F, phenol-novolak, cresol-novolak, bisphenol A-novolak, xylene-novolak, melamine-novolak, p-hydroxystyrene (co)polymer, and halides and alkylated derivatives of these phenols.

The acid anhydrides include hexahydrophthalic anhydride (HPA), tetrahydrophthalic anhydride (THPA), pyromellitic anhydride (PMDA), chlorendic anhydride (HET), nadic anhydride (NA), methylnadic anhydride (MNA), dodecynylsuccinic anhydride (DDSA), phthalic anhydride (PA), methylhexahydrophthalic anhydride (MeHPA), and maleic anhydride.

These curing agents may be used singly or in combination of two or more kinds. The amount of the curing agent(s) (D) is preferably 1 to 100 parts by weight, more preferably 10 to 70 parts by weight relative to 100 parts by weight of the epoxy resin (A).

(E) Curing Catalyst

The curing catalysts (E) for use in the present invention are not particularly limited, and include amines, carboxylic acids, acid anhydrides, dicyandiamides, dibasic acid dihydrazides, imidazoles, organoborons, organophosphines, guanidines, and salts thereof. They may be used singly or in combination of two or more kinds.

The amount of the curing catalyst(s) (E) is preferably 0.1 to 20 parts by weight, more preferably 0.5 to 10 parts by weight, relative to 100 parts by weight of the epoxy resin (A). A curing accelerator may be used as required together with the curing catalyst (E) to accelerate the curing reaction. Here, the “curing agent” is a substance that forms crosslinkage itself, the “curing catalyst” is a substance that does not form crosslinkage itself but facilitates the crosslinking reaction, and the “curing accelerator” is a substance that increases the catalytic activity of the curing catalyst.

(F) Organic Solvent

In the present invention, organic solvents may be used as required to improve handling properties of the thermosetting resin composition or to adjust the viscosity or storage stability of the composition. The organic solvents (F) for use in the present invention are not particularly limited and include:

ethylene glycol monoalkyl ether acetates such as ethylene glycol monomethyl ether acetate and ethylene glycol monoethyl ether acetate;

propylene glycol monoalkyl ethers such as propylene glycol monomethyl ether, propylene glycol monoethyl ether,

propylene glycol monopropyl ether, and propylene glycol monobutyl ether;

propylene glycol dialkyl ethers such as propylene glycol dimethyl ether, propylene glycol diethyl ether, propylene glycol dipropyl ether, and propylene glycol dibutyl ether; propylene glycol monoalkyl ether acetates such as propylene glycol monomethyl ether acetate, propylene glycol monoethyl ether acetate, propylene glycol monopropyl ether acetate, and propylene glycol monobutyl ether acetate;

cellosolves such as ethyl cellosolve and butyl cellosolve;

carbitols such as butyl carbitol;

lactates such as methyl lactate, ethyl lactate, n-propyl lactate, and isopropyl lactate;

aliphatic carboxylates such as ethyl acetate, n-propyl acetate, isopropyl acetate, n-butyl acetate, isobutyl acetate, n-amyl acetate, isoamyl acetate, isopropyl propionate, n-butyl propionate, and isobutyl propionate;

other esters such as methyl 3-methoxypropionate, ethyl 3-methoxypropionate, methyl 3-ethoxypropionate, ethyl 3-ethoxypropionate, methyl pyruvate, and ethyl pyruvate;

aromatic hydrocarbons such as toluene and xylene;

ketones such as 2-butanone, 2-heptanone, 3-heptanone, 4-heptanone, methyl amyl ketone, and cyclohexanone;

amides such as N-dimethylformamide, N-methylacetamide, N,N-dimethylacetamide, and N-methylpyrrolidone; and

lactones such as γ-butyrolactone.

These organic solvents may be used singly or as a mixture of two or more kinds.

(G) Other Resins

The thermosetting resin composition according to the present invention may also contain, as required, a resin other than the above epoxy resin. Examples thereof include thermoplastic or thermosetting resins such as resins having a phenolic hydroxyl group, polyimides, acrylic polymers, polystyrene resins, phenoxy resins, polyolefin elastomers, styrene/butadiene elastomers, silicon elastomers, diisocyanates such as tolylene diisocyanate and blocked diisocyanates derived therefrom, high-density polyethylenes, medium-density polyethylenes, polypropylenes, polycarbonates, polyallylates, polyamides, polyamideimides, polysulfones, polyether sulfones, polyether ketones, polyphenylene sulfides, (modified) polycarbodiimides, polyetherimides, polyesterimides, modified polyphenylene oxides, and oxetane group-containing resins. These resins may be used in such an amount that the effects of the present invention are not impaired.

(H) Other Additives

The thermosetting resin composition according to the present invention may also contain, as required, an adhesion auxiliary, leveling agent, inorganic filler, macromolecular additive, reactive diluent, wettability improver, surfactant, plasticizer, antistatic agent, antifungal agent, humidity adjuster, flame retardant, and other additives. These additives may be used in such an amount that the effects of the present invention are not impaired. The composition may also contain a resin other than the epoxy resin (A) (hereafter, also referred to as “other resin”).

(Production of Thermosetting Resin Composition)

The thermosetting resin composition of the present invention can be produced, for example, by mixing the above-described components, that is, the epoxy resin (A), the crosslinked diene-based rubber (B), and the curing agent (D) and/or the curing catalyst (E), and optionally other components such as the solvent and the antioxidant (C). Conventional methods for producing thermosetting resin compositions can be suitably used, in which the above components are added either at a time or in an arbitrary order and are mixed together and dispersed by stirring. For example, the epoxy resin (A) may be dissolved in the organic solvent (F) to prepare a varnish, and the crosslinked diene-based rubber (B) and the curing agent (D) and/or the curing catalyst (E) may be added to the varnish.

(Thermosetting Resin Composition)

The thermosetting resin composition according to the present invention contains at least the epoxy resin (A), the crosslinked diene-based rubber (B), the curing agent (D), and the curing catalyst (E), and these components are well compatible with one another. Heat-curing this thermosetting resin composition provides a cured product with excellent electrical properties, such as low dielectric constant and low dielectric loss, and excellent insulation properties. Furthermore, the thermosetting resin composition which further contains the antioxidant (C) or in which the crosslinked diene-based rubber (B) is the specific functional group-containing styrene/butadiene-based copolymer, can give a heat-cured product that shows only quite minor changes in physical properties before and after a reliability test and is excellent in mechanical properties, thermal shock resistance, and heat resistance.

Therefore, the thermosetting resin composition according to the present invention can be quite suitably used, in particular, for interlayer insulating films or flattening films in multilayer circuit boards, protective or electrical insulating films in various electric instruments and electronic components, adhesives for various electronic parts, capacitor films, and the like. The composition is also suitable for use as a sealant for semiconductors, underfilling material, sealant for liquid crystals, and the like.

Moreover, the thermosetting resin composition according to the present invention can be used as a thermosetting shaping material in a form of powder or pellets.

Still further, the thermosetting resin composition according to the present invention can be used as laminate members of copper-clad laminates and the like, wherein glass cloth or other base is impregnated with the composition to give prepregs. Such prepregs may be obtained by impregnating glass cloth or other base with the thermosetting resin composition of the present invention without dilution or may be obtained by impregnating glass cloth or other base with a solution of the thermosetting resin composition in a solvent.

The thermosetting resin composition according to the present invention may be applied to a copper foil to form a thermosetting thin film, and such thin film may be used as an insulating adhesive layer for flexible printed wiring boards.

<Thermosetting Film>

To produce the thermosetting film according to the present invention, a suitable support having a release-treated surface may be coated with the thermosetting resin composition to form a thermosetting thin film, and the thin film may be released from the support without heat-curing. The thermosetting film obtained can be used as a low-stress adhesive film or (insulating) adhesive film in electronic components such as printed wiring boards or electric instruments.

The above support is not particularly limited. Examples thereof include metals such as iron, nickel, stainless steel, titanium, aluminum, copper, and various alloys; ceramics such as silicon nitride, silicon carbide, sialon, aluminum nitride, boron nitride, boron carbide, zirconia, titaniumoxide, alumina, silica, and mixtures thereof; semiconductors such as Si, Ge, SiC, SiGe, and GaAs; ceramic industry materials such as glass and pottery; and heat-resistant resins such as polyamides, polyamideimides, polyimides, PBT (polybutylene terephthalate), PET (polyethylene terephthalate), and wholly aromatic polyesters. As required, the support may be release treated beforehand, or may be appropriately pretreated by chemical treatment with a silane coupling agent, titanium coupling agent or the like, or by plasma treatment, ion plating, sputtering, vapor-phase reaction processing, or vacuum deposition.

The support may be coated with the thermosetting resin composition by a known coating method. Examples of the methods include dipping, spraying, bar coating, roll coating, spin coating, curtain coating, gravure printing, silk screen printing, and ink-jet printing. The thickness of coating can be suitably controlled by selecting the coating means or adjusting the solid content or viscosity of the composition solution.

<Cured Thermosetting Resin Product>

The cured thermosetting resin product according to the present invention can be produced from the thermosetting resin composition, for example, by the following methods. The cured product is excellent in electrical properties and electric insulation properties. Moreover, when the composition includes the antioxidant (C) or the specific functional group-containing styrene/butadiene copolymer, the cured product shows only quite minor changes in physical properties before and after a reliability test, and is also excellent in thermal shock resistance and heat resistance.

The thermosetting resin composition may be applied to a suitable surface-treated support to form a thermosetting thin film, and the thin film together with the support may be transferred to a base using a laminator, followed by curing. Consequently, a substrate having a layer of the cured product and a layer of the support may be produced. The support used herein may be the same as that used in producing the thermosetting film described above.

The cured film of the thermosetting resin composition, which is one of the cured products according to the invention, can be produced by heat-curing the thermosetting film described above. Alternatively, the cured film can be produced as follows: a release-treated suitable support is coated with the thermosetting resin composition to form a thermosetting film layer, this thermosetting film layer is heat-cured, and the cured film layer is released from the support. The support used herein may be the same as that used in producing the thermosetting film described above.

The conditions for curing the thermosetting resin composition are not particularly limited and may be selected according to application of the cured product and the type of the curing agent and/or curing catalyst. For example, the composition can be cured by heating at a temperature in the range of 50 to 200° C. for about 10 minutes to 48 hours.

To make sure that the composition is sufficiently cured and foams are avoided, the heating may be conducted in two steps. For example, the composition may be cured by heating at 50 to 100° C. for about 10 minutes to 10 hours in the first step and may be further cured by heating at 80 to 200° C. for about 30 minutes to 12 hours in the second step.

Provided that the curing conditions are as described above, the heating apparatus may be a common oven, infrared furnace or the like.

As described above, the cured thermosetting resin product according to the present invention possesses excellent electrical properties and electric insulation properties. Consequently, the cured film of the thermosetting resin composition may be used as an insulating layer in electronic components such as semiconductor devices, semiconductor packages and printed wiring boards.

The cured product of the thermosetting resin composition which contains the antioxidant (C) or the specific functional group-containing styrene/butadiene copolymer has favorable properties. For example, the modulus in tension measured according to JIS K7113 (tensile test method for plastics) (hereafter, simply referred to as “elastic modulus”) is usually 1.5 GPa or less, preferably 1.0 GPa or less, and the cured product is more resistant to cracks even under environments with large temperature variation, shows only quite minor changes in physical properties before and after a reliability test, and has excellent thermal shock resistance and heat resistance.

### EXAMPLES

Hereafter, the present invention will be explained with Examples, but the present invention is not limited by these Examples. In Synthesis Examples, Examples and Comparative Examples below, “parts” means “parts by weight” unless otherwise defined. The cured products obtained in Examples and Comparative Examples were evaluated by the following methods.

Examples 1-1 to 1-7 and Comparative Example 1-1 will be explained first. The materials used in these Examples and methods for evaluating physical properties of the cured products are shown below.

(A1) Epoxy Resins

A1-1: Phenol/biphenylene glycol condensate-type epoxy resin (trade name: NC-3000P; manufactured by Nippon Kayaku Co. Ltd.)
A1-2: Phenol-naphthol/formaldehyde condensate-type epoxy resin (trade name: NC-7000L; manufactured by Nippon Kayaku Co., Ltd.)
A1-3: Phenol/dicyclopentadiene-type epoxy resin (trade name: XD-1000; manufactured by Nippon Kayaku Co., Ltd.)
   (B1) Diene-Based Rubbers
   B1-1: Butadiene/styrene/methacrylic acid/divinylbenzene=75/20/2/3 (weight ratio)

(Tg: −48° C., average particle diameter: 70 nm)

B1-2: Butadiene/styrene/hydroxybutyl methacrylate/methacrylic acid/divinylbenzene=50/10/32/6/2 (weight ratio)

(Tg: −45° C., average particle diameter: 65 nm)

B1-3: Butadiene/acrylonitrile/methacrylic acid/hydroxybutyl methacrylate/divinylbenzene=78/5/5/10/2 (weight ratio)

(Tg: −40° C., average particle diameter: 70 nm, content of bonded nitrile: 4.8%)

B1-4: Butadiene/styrene/hydroxybutyl methacrylate/methacrylic acid/pentaerythritol triacrylate=68/10/20/3 (weight ratio)

(Tg: −45° C., average particle diameter: 75 nm)

B1-5: Butadiene/acrylonitrile/methacrylic acid/divinylbenzene=62/30/5/3 (weight ratio)

(Tg: −45° C., average particle diameter: 70 nm)

(C1) Antioxidants

C1-1: Nonflex RD (trade name, manufactured by Seiko Chemical Co., Ltd.)

C1-2: Antage SP (trade name, manufactured by Kawaguchi Chemical Industry Co., Ltd.)

C1-3: Nocrac G1 (trade name, manufactured by Ouchi Shinko Chemical Industrial Co., Ltd.)

C1-4: Irganox #1010 (trade name, manufactured by Ciba Specialty Chemicals Co., Ltd.)

(D1) Curing Agents

D1-1: Phenol/xylylene glycol condensate resin (trade name: XLC-LL; manufactured by Mitsui Chemicals, Inc.)

D1-2: Phenol-novolak resin (manufactured by Showa Highpolymer Co., Ltd., trade name: CRG-951)

D1-3: Dicyandiamide

(E1) Curing Catalysts

E1-1: 2-Ethylimidazole

E1-2: 1-Cyanoethyl-2-ethyl-4-methylimidazole

(F1) Organic solvents

F1-1: 2-Heptanone

F1-2: Ethyl lactate

F1-3: Propylene glycol monomethyl ether acetate

<Evaluation Methods for Physical Properties>

(1) Content of Bonded Acrylonitrile

The diene-based rubber was precipitated from the latex with methanol, and was purified and dried in vacuum. The dried product was analyzed by elemental analysis to obtain a nitrogen content. The content of bonded acrylonitrile was determined from the nitrogen content.

(2) Glass Transition Temperature

The resin composition was applied onto a PET film, heated at 80° C. for 30 minutes in a convection oven, and further heated at 170° C. for 2 hours. Then, the PET film was removed to prepare a 50-μm thick cured film. From this cured film, a 3 mm×20 mm specimen (50 μm thick) was obtained, and the glass transition temperature (Tg) was determined by the DSC method using this specimen.

(3) Elastic Modulus

The resin composition was applied onto a PET film, heated at 80° C. for 30 minutes in a convection oven, and further heated at 170° C. for 2 hours. Then, the PET film was removed to prepare a 50-μm thick cured film. From this cured film, a 3 mm×20 mm specimen (50 μm thick) was obtained, and the elastic modulus was measured by the TMA method using this specimen.

(4) Electric Insulation Properties (Volume Resistivity)

The resin composition was applied onto a SUS substrate, and heated in a convection oven at 80° C. for 30 minutes to form a 50-μm thick uniform resin coating. It was further heated at 170° C. for 2 hours to prepare a cured film. This cured film was subjected to a durability test at 85° C. and a humidity of 85% for 500 hours in a constant-temperature and humidity chamber (manufactured by Tabai Espec Corp.). According to JIS C6481, the volume resistivity of the cured film was measured before and after the test.

(5) Thermal Shock Resistance

The resin composition was applied on a release-treated PET film and heated in a convection oven at 80° C. for 30 minutes to form a 50-μm thick uniform resin coating. It was further heated at 170° C. for 2 hours to prepare a cured film. This cured film was tested on a thermal shock tester (TSA-40L, manufactured by Tabai Espec Corp.), wherein a cycle consisting of cooling at −65° C. for 30 minutes and heating at 150° C. for 30 minutes was repeated 1000 times.

(6) Dielectric Constant and Dielectric Loss

The thermosetting resin composition was applied onto a mirror-finished SUS plate, heated at 80° C. for 30 minutes in a convection oven, and further heated at 170° C. for 2 hours to form a 10-μm thick cured film on the SUS plate. An aluminum electrode was formed on this cured film, and the dielectric constant and the dielectric loss were measured at a frequency of 1 MHz with a dielectric constant/dielectric loss measuring device (LCR meter HP4248, manufactured by Hewlett-Packard Co.).

### Example 1-1

As shown in Table 1, 100 parts by weight of the epoxy resin (A1-1), 30 parts by weight of the diene-based rubber (B1-1), 5 parts by weight of the antioxidant (C1-1), 70 parts by weight of the curing agent (D1-1), and the curing catalyst (E1-1) were dissolved in 200 parts by weight of the organic solvent (F1-1). Cured products were obtained from the solution and were measured for glass transition temperature, elastic modulus, electrical properties, electric insulation properties, and glass transition temperature and elastic modulus after the thermal shock test by the above evaluation methods. The results are shown in Table 1.

### Examples 1-2 to 1-7

The characteristics of the cured products were measured in the same manner as in Example 1-1 except that the resin compositions were prepared from the components shown in Table 1. The results are shown in Tables 1 and 2.

### Comparative Example 1-1

The characteristics of the cured product were measured in the same manner as in Example 1-1 except that the resin composition was prepared from the components shown in Table 2. The results are shown in Table 2.

[Table 1]

TABLE 1

| | Example | Example | Example | Example |
|---|---|---|---|---|
| | 1-1 | 1-2 | 1-3 | 1-4 |
| (A1) Epoxy resin (parts) | | | | |
| A1-1 | 100 | — | — | 100 |
| A1-2 | — | 100 | — | — |
| A1-3 | — | — | 100 | — |
| (B1) Diene-based rubber (parts) | | | | |
| B1-1 | 30 | — | — | 150 |
| B1-2 | — | 15 | — | — |
| B1-3 | — | — | 20 | — |
| B1-4 | — | 15 | — | — |
| (C1) Antioxidant (parts) | | | | |
| C1-1 | 5 | — | — | — |
| C1-2 | — | 10 | — | — |
| C1-3 | — | — | 5 | — |
| C1-4 | — | — | — | 20 |
| (D1) Curing agent (parts) | | | | |
| D1-1 | 70 | — | — | 35 |
| D1-2 | — | 70 | — | — |
| D1-3 | — | — | 50 | — |
| (E1) Curing catalyst (parts) | | | | |
| E1-1 | 2 | — | 1 | — |
| E1-2 | — | 4 | — | 3 |
| (F1) Organic solvent (parts) | | | | |
| F1-1 | — | 210 | — | — |
| F1-2 | — | — | 170 | 285 |
| F1-3 | 200 | — | — | — |
| Initial physical properties | | | | |
| Glass transition temperature (° C.) | 170 | 150 | 160 | 175 |
| Elastic modulus (GPa) | 1.5 | 1.2 | 1.4 | 0.2 |
| Dielectric constant (1 MHz) | 3.3 | 3.4 | 3.4 | 3.4 |
| Dielectric loss (1 MHz) | 0.008 | 0.010 | 0.008 | 0.016 |
| Volume resistivity (ohm · cm) | | | | |
| Before test | 6 × 10¹⁵ | 3 × 10¹⁵ | 8 × 10¹⁵ | 2 × 10¹⁵ |
| After test | 5 × 10¹⁴ | 4 × 10¹⁴ | 4 × 10¹⁴ | 7 × 10¹⁴ |
| Physical properties after | | | | |
| thermal shock test | | | | |
| Glass transition temperature (° C.) | 172 | 173 | 161 | 177 |
| Elastic modulus (GPa) | 1.5 | 1.2 | 1.4 | 0.2 |

TABLE 2

| | | | | Compar- |
|---|---|---|---|---|
| | | | | ative |
| | Example | Example | Example | Example |
| | 1-5 | 1-6 | 1-7 | 1-1 |
| (A1) Epoxy resin (parts) | | | | |
| A1-1 | 100 | — | 100 | 100 |
| A1-2 | — | 100 | — | — |
| A1-3 | — | — | — | — |
| (B1) Diene-based rubber (parts) | | | | |
| B1-1 | — | — | — | — |
| B1-2 | — | — | — | — |
| B1-3 | — | 40 | 30 | — |
| B1-4 | 100 | — | — | — |
| B1-5 | — | — | — | 50 |
| (C1) Antioxidant (parts) | | | | |
| C1-1 | — | — | — | — |
| C1-2 | — | 15 | — | — |
| C1-3 | 10 | — | — | — |
| C1-4 | — | — | — | 10 |
| (D1) Curing agent (parts) | | | | |
| D1-1 | 30 | — | — | — |
| D1-2 | — | 70 | 70 | 70 |
| (E1) Curing catalyst (parts) | | | | |
| E1-1 | 2 | — | 2 | 2 |
| E1-2 | — | 2 | — | — |
| (F1) Organic solvent (parts) | | | | |
| F1-1 | 230 | 210 | — | — |
| F1-2 | — | — | 200 | 220 |
| (G1) Additive | | | | |
| Silica (parts) | — | 30 | — | — |
| Initial physical properties | | | | |
| Glass transition temperature (° C.) | 170 | 170 | 180 | 170 |
| Elastic modulus (GPa) | 0.3 | 2.0 | 1.6 | 1.2 |
| Dielectric constant (1 MHz) | 3.4 | 3.5 | 3.4 | 4.0 |
| Dielectric loss (1 MHz) | 0.012 | 0.010 | 0.010 | 0.050 |
| Volume resistivity (ohm · cm) | | | | |
| Before test | 6 × 10¹⁵ | 3 × 10¹⁵ | 8 × 10¹⁵ | 2 × 10¹³ |
| After test | 5 × 10¹⁴ | 4 × 10¹⁴ | 4 ×× 10¹⁴ | 7 × 10¹⁰ |
| Physical properties after | | | | |
| thermal shock test | | | | |
| Glass transition temperature (° C.) | 172 | 173 | 181 | 177 |
| Elastic modulus (GPa) | 0.3 | 2.0 | 2.0 | 1.2 |

Next, Examples 2-1 to 2-3 and Comparative Example 2-1 are explained. The following are the materials used in these Examples and methods for evaluating physical properties of the cured products.

(A2) Epoxy Resins

A2-1: Phenol/biphenylene glycol condensate-type epoxy resin (trade name: NC-3000P, manufactured by Nippon Kayaku Co., Ltd., softening point: 53 to 63° C.)
A2-2: Phenol-naphthol/formaldehyde condensate-type epoxy resin (trade name: NC-7000L, manufactured by Nippon Kayaku Co., Ltd., softening point: 83 to 93° C.)
A2-3: o-Cresol/formaldehyde condensate novolak-type epoxy resin (trade name: EOCN-104S, manufactured by Nippon Kayaku Co., Ltd., softening point: 90 to 94° C.)
   (D2) Curing Agents
D2-1: Phenol/xylylene glycol condensate resin (trade name: XLC-LL, manufactured by Mitsui Chemicals, Inc.)
   D2-2: 2-Ethylimidazole
   D2-3: 1-Cyanoethyl-2-ethyl-4-methylimidazole
   (F2) Organic Solvents
   F2-1: 2-Heptanone
   F2-2: Ethyl lactate

The following are Synthesis Examples describing synthesis of styrene/butadiene copolymers (hereafter, also referred to as “SB copolymers”) and acrylonitrile/butadiene copolymers (hereafter, also referred to as “NB copolymer”) used as crosslinked rubber particles.

### Synthesis Example 1

### (Synthesis of SB copolymer (B2-1))

An autoclave was charged with an aqueous solution of 5 parts of sodium dodecylbenzenesulfonate in 200 parts of distilled water, and with 70 parts of butadiene, 18 parts of styrene, 5 parts of 2-hydroxybutyl methacrylate, and 5 parts of methacrylic acid as material monomers, and a redox catalyst. After the temperature was adjusted at 10° C., 0.01 parts of cumenehydroxide were added as a polymerization initiator, and the emulsion polymerization was conducted until the polymerization conversion reached 85%. Then, reaction terminator N,N-diethylhydroxylamine was added to obtain a copolymer emulsion. After steam was blown into this solution to remove unreacted material monomers, the solution was added to a 5% aqueous calcium chloride solution, and the deposited copolymer was dried in a ventilation oven at 80° C. A SB copolymer (B2-1) was thus isolated. The glass transition temperature (Tg) of the SB copolymer (B2-1) was measured by the DSC method, resulting in −55° C.

### Synthesis Example 2

### (Synthesis of SB copolymer (B2-2))

A SB copolymer (B2-2) was synthesized and isolated in the same manner as in Synthesis Example 1 except that 60 parts of butadiene, 20 parts of styrene, 18 parts of 2-hydroxybutyl methacrylate, and 2 parts of divinylbenzene were used as material monomers. The glass transition temperature (Tg) of the SB copolymer (B2-2) was measured by the DSC method, resulting in −45° C.

### Synthesis Example 3

### (Synthesis of SB copolymer (B2-3))

A SB copolymer (B2-3) was synthesized and isolated in the same manner as in Synthesis Example 1 except that 63 parts of butadiene, 20 parts of styrene, 10 parts of 2-hydroxybutyl methacrylate, 5 parts of methacrylic acid, and 2 parts of divinylbenzene were used as material monomers. The glass transition temperature (Tg) of the SB copolymer (B2-3) was measured by the DSC method, resulting in −40° C.

### Synthesis Example 4

### (Synthesis of SB copolymer (B2-4))

A SB copolymer (B2-4) was synthesized and isolated in the same manner as in Synthesis Example 1 except that 63 parts of butadiene, 20 parts of styrene, 5 parts of 2-hydroxybutyl methacrylate, and 5 parts of glycidyl methacrylate were used as material monomers. The glass transition temperature (Tg) of the SB copolymer (B2-4) was measured by the DSC method, resulting in −57° C.

### Synthesis Example 5

### (Synthesis of SB copolymer (B2-5))

A SB copolymer (B2-5) was synthesized and isolated in the same manner as in Synthesis Example 1 except that 20 parts of butadiene, 68 parts of styrene, 5 parts of 2-hydroxybutyl methacrylate, 5 parts of methacrylic acid, and 2 parts of divinylbenzene were used as material monomers. The glass transition temperature (Tg) of the SB copolymer (B2-5) was measured by the DSC method, resulting in 12° C.

### Synthesis Example 6

### (Synthesis of NB copolymer (b-6))

A NB copolymer (b-6) was synthesized and isolated in the same manner as in Synthesis Example 1 except that 70 parts of butadiene, 20 parts of acrylonitrile, 5 parts of 2-hydroxybutyl methacrylate, and 5 parts of methacrylic acid were used as material monomers. The glass transition temperature (Tg) of the NB copolymer (b-6) was measured by the DSC method, resulting in −55° C.

### Synthesis Example 7

### (Synthesis of NB copolymer (b-7))

A NB copolymer (b-7) was synthesized and isolated in the same manner as in Synthesis Example 1 except that 60 parts of butadiene, 20 parts of acrylonitrile, 18 parts of 2-hydroxybutyl methacrylate, and 2 parts of divinylbenzene were used as material monomers. The glass transition temperature (Tg) of the NB copolymer (b-7) was measured by the DSC method, resulting in −42° C.

(1) Electrical Properties

The thermosetting resin composition was applied on a mirror-finished SUS plate and heated at 80° C. for 30 minutes in a convection oven. It was further heated at 150° C. for 4 hours to form a 10-μm thick cured film on the SUS plate. An aluminum electrode was formed on this cured film, and the dielectric constant and dielectric loss were measured at a frequency of 1 MHz with a dielectric constant/dielectric loss measuring device (LCR meter HP4248, manufactured by Hewlett-Packard Co.)

(2) Glass Transition Temperature

The thermosetting resin composition was applied on a PET film and heated at 80° C. for 30 minutes in a convection oven. The composition was further heated at 150° C. for 4 hours, and the PET film was removed to obtain a 50-μm thick cured film. This cured film was cut with a dumbbell into a 3-mm wide specimen, with which the glass transition temperature (Tg) was measured by the TMA viscoelastic analysis using a thermomechanical analyzer (TMA/SS6100, manufactured by Seiko Instruments Inc.)

(3) Electric Insulation Properties (Volume Resistivity)

The thermosetting resin composition was applied on a mirror-finished SUS plate and heated at 80° C. for 30 minutes in a convection oven to form a 50-μm thick uniform resin coating. It was further heated at 150° C. for 4 hours to form a cured film. This cured film was subjected to a durability test at 85° C. and a humidity of 85% for 500 hours in a constant temperature and humidity chamber (manufactured by Tabai Espec Corp.). The volume resistivity of the cured film was measured before and after the durability test according to JIS C6481.

(4) Elastic Modulus

A 50-μm thick cured film was formed as described in the measurement of the glass transition temperature in (2), and a 5-mm wide specimen was punched out from this cured film with a dumbbell. This specimen was subjected to a tensile test according to JIS K7113 (tensile test method for plastics), and the modulus in tension was obtained as elastic modulus. In JIS K7113, the modulus in tension is defined as a ratio of the tensile stress to the strain corresponding thereto within a tensile proportional limit (initial linear part of a stress-strain curve).

(5) Thermal Shock Resistance

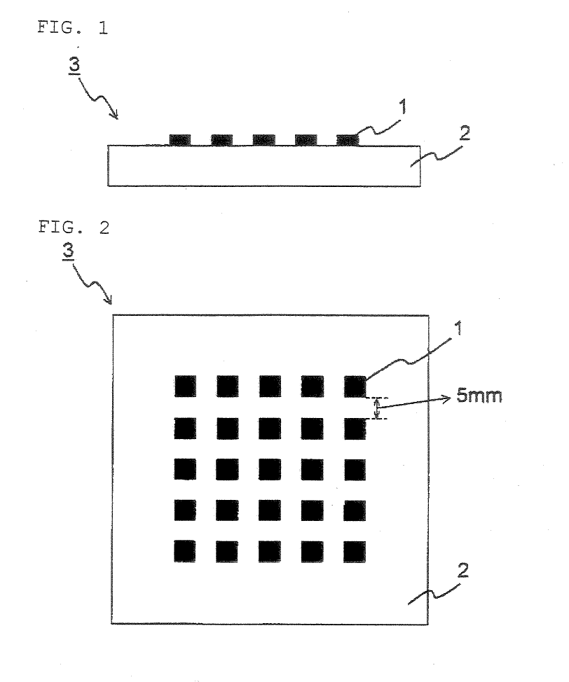

The thermosetting resin composition was applied on a patterned board shown in FIG. 1 and heated in a convection oven at 80° C. for 30 minutes to form a 50-μm thick uniform resin coating It was further heated at 150° C. for 4 hours to form a cured film on the board. This board with the cured film was subjected to a thermal shock test in a thermal shock chamber (TSA-40L, manufactured by Tabai Espec Corp.) where a cycle consisting of cooling at −65° C. for 30 minutes and heating at 150° C. for 30 minutes was repeated. Defects such as cracks on the cured resin were inspected every 100 cycles until 1000 cycles, and the thermal shock resistance was evaluated based on the number of cycles at which cracking occurred. When no crack was caused after 1000 cycles, the thermal shock resistance was evaluated as “no crack”.

### Examples 2-1 to 2-4

A thermosetting resin composition was prepared by dissolving the epoxy resin (A2), the styrene/butadiene-based copolymer (B2), and the curing agent (D2) in the solvent (F2) as shown in Table 3. Cured films were produced from the thermosetting resin composition and were measured for properties by the above evaluation methods. The results are shown in Table 3.

### Comparative Examples 2-1 to 2-3

A thermosetting resin composition composed of the components shown in Table 3 was prepared in the same manner as in Example 2-1. Cured films were produced therefrom and were measured for properties in the same manner as in Example 2-1. The results are shown in Table 3.

[Table 3]

TABLE 3

| | | | | | Comp. | Comp. | Comp. |
|---|---|---|---|---|---|---|---|
| | Ex. 2-1 | Ex. 2-2 | Ex. 2-3 | Ex. 2-4 | Ex. 2-1 | Ex. 2-2 | Ex. 2-3 |
| (A2) Epoxy resin (parts) | | | | | | | |
| A2-1 | 100 | | | | 100 | | |
| A2-2 | | 100 | | | | 100 | |
| A2-3 | | | 100 | 100 | | | 100 |
| (B2) SB Copolymer (parts) | | | | | | | |
| B2-1 | 50 | | | | | | |
| B2-2 | | 100 | | | | | |
| B2-3 | | | 100 | | | | |
| B2-4 | | | | 100 | | | |
| B2-5 | | | | | | | 100 |
| (b) NB Copolymer (parts) | | | | | | | |
| b-6 | | | | | 50 | | |
| b-7 | | | | | | 100 | |
| (D2) Curing agent (parts) | | | | | | | |
| D2-1 | 50 | 50 | 50 | 50 | 50 | 50 | 50 |
| D2-2 | 2 | | 3 | 3 | 2 | | 3 |
| D2-3 | | 4 | | | | 4 | |
| (F2) Solvent (parts) | | | | | | | |
| F2-1 | 300 | 400 | | | 300 | | |
| F2-2 | | | 300 | 300 | | 400 | 400 |
| Dielectric constant (1 MHz) | 3.3 | 3.3 | 3.2 | 3.3 | 4.1 | 4.7 | 3.3 |
| Dielectric loss (1 MHz) | 0.01 | 0.01 | 0.01 | 0.01 | 0.12 | 0.15 | 0.01 |
| Glass transition temperature (° C.) | 150 | 172 | 170 | 170 | 150 | 170 | 170 |
| Elastic modulus (GPa) | 1.5 | 0.6 | 0.7 | 0.6 | 1.5 | 0.7 | 3.0 |
| Volume resistivity (ohm · cm) | | | | | | | |
| Before test | 6 × 10¹⁵ | 3 × 10¹⁵ | 5 × 10¹⁵ | 6 × 10¹⁵ | 7 × 10¹⁵ | 5 × 10¹⁵ | 3 × 10¹⁵ |
| After test | 8 × 10¹⁵ | 5 × 10¹⁴ | 7 × 10¹⁴ | 5 × 10¹⁴ | 5 × 10¹⁴ | 8 × 10¹⁴ | 7 × 10¹⁴ |
| Thermal shock resistance (after 1000 | No crack | No crack | No crack | No crack | No crack | No crack | 300 |
| cycles or cycle number at cracking) | | | | | | | |

### INDUSTRIAL APPLICABILITY

The thermosetting resin composition and cured product thereof according to the present invention can produce, for example, interlayer insulating films that enable multilayer circuit boards to exhibit excellent electrical properties.

1: A thermosetting resin composition comprising an epoxy resin (A), a crosslinked diene-based rubber (B) in which the content of bonded acrylonitrile is less than 10 wt %, and a curing agent (D) and/or a curing catalyst (E).

2: The thermosetting resin composition according to claim 1, wherein the crosslinked diene-based rubber (B) is a copolymer which has one or more glass transition temperatures of which at least one glass transition temperature is 0° C. or less, and which includes units derived from a crosslinking monomer having at least two polymerizable unsaturated bonds and is free of acrylonitrile.

3: The thermosetting resin composition according to claim 1, wherein the crosslinked diene-based rubber (B) is a styrene/butadiene-based copolymer having at least one kind of functional group selected from carboxyl group, hydroxyl group and epoxy group.

4: The thermosetting resin composition according to claim 3, wherein the styrene/butadiene-based copolymer is obtained from 5 to 40 parts by weight of styrene, 40 to 90 parts by weight of butadiene, and 1 to 30 parts by weight of a monomer having at least one kind of functional group selected from carboxyl group, hydroxyl group and epoxy group, based on 100 parts by weight of the material monomers combined.

5: The thermosetting resin composition according to claim 3, wherein the styrene/butadiene-based copolymer is obtained from 5 to 40 parts by weight of styrene, 40 to 90 parts by weight of butadiene, 1 to 30 parts by weight of a monomer having at least one kind of functions group selected from carboxyl group, hydroxyl group and epoxy group, and 0.5 to 10 parts by weight of a monomer having at least two polymerizable unsaturated double bonds, based on 100 parts by weight of the material monomers combined.

6: The thermosetting resin composition according to claim 1, wherein the crosslinked diene-based rubber (B) is in a form of crosslinked fine particles.

7: The thermosetting resin composition according to claim 6, wherein the diameters of the crosslinked fine particles are in the range of 30 to 500 nm.

8: The thermosetting resin composition according to claim 1, wherein the thermosetting resin composition is capable of giving a heat-cured product having an elastic modulus of 1.5 GPa or less.

9: A cured product obtained by heat-curing the thermosetting resin composition of claim 1.

10: A thermosetting film comprising the thermosetting resin composition claim 1.

11: A cured film obtained by heat-curing the thermosetting film of claim 10.

12: An electronic component having an insulating layer comprising the thermosetting resin composition of claim 1.
